(19) United States
(12) Patent Application Publication
(10) Pub. No.: US 2011/0085297 A1
(43) Pub. Date: Apr. 14, 2011

(54) Self Releasing Hinge

(75) Inventors: Mark Warren WRIGHT-JOHNSON, Weston, FL (US); Timothy Joseph HARDING, Spokane, WA (US)

(73) Assignee: General Dynamics C4 Systems, Inc., Spokane, WA (US)

(21) Appl. No.: 12/578,853

(22) Filed: Oct. 14, 2009

(51) Int. Cl. G06F 1/16; E05D 3/00

(52) U.S. Cl. 361/679.55; 16/367

(57) ABSTRACT

The exemplary embodiments describe a device, such as a laptop computer, having a base assembly and a display panel joined by a hinge mechanism that allows for the display panel to rotate in either a clockwise or counterclockwise direction and pivot with respect to the base assembly.

### TECHNICAL FIELD

The present invention generally relates to a device with a rotatable display and, more particularly, to a laptop with a self-releasing and self-engaging mechanism for a rotatable display.

### BACKGROUND

Portable laptop computers are used widely. They come in a variety of configurations, including notebook or tablet style. A convertible tablet laptop is an alternative to conventional laptops, desktops, or PDAs, as it offers enhanced portability and multiple working positions—a display mode and a regular laptop mode. Convertible laptops combine many advantages of both notebook style computers and tablet style computers. Some of those advantages are accomplished by using a hinge mechanism to connect the laptop's base to its display. Those mechanism allow the display to rotate 180°, or even a full 360°. Most hinge mechanisms are single-hinge designs centered behind the laptop's keyboard. These single-hinge designs suffer from many deficiencies because of their frailty, which is particularly evident on larger computers, or those used outdoors or mounted in vehicles.

Until now, efforts to design robust hinge mechanisms for devices with a rotatable display have had limited success. Some attempts have included a hinge mechanism that uses one or more side hinges for robustness. But such hinge mechanisms typically require an additional component, namely a manual locking device for the side hinges. Manual locking devices make tablet laptops cumbersome. They prevent users from quickly and easily swiveling the laptop display to a tablet position. There remains a need for a laptop having a robust, self-engaging and self-releasing hinge mechanism.

The exemplary embodiments of the disclosed hinge mechanism are not limited to laptops and can be used in other devices, such as DVD players, GPS systems, storage systems, or cell phones.

### SUMMARY OF THE EMBODIMENTS

In a first exemplary embodiment, a hinge assembly is provided. The hinge assembly may be used in a laptop computer. The hinge assembly may include a swivel hinge attached to a base assembly and to a display panel, the swivel hinge adapted to allow the display panel to pivotally and rotationally move with respect to the base assembly. The hinge assembly may further include one or more side hinges attached to the base assembly, the one or more side hinges being generally collinear with the swivel hinge and having a slot formed therethrough, wherein the one or more tabs are adapted to engage and release the display panel when the display panel is in a hinge free angle.

In a second exemplary embodiment, a device is provided. The device may include a base assembly, a panel pivotally attached to the base assembly and having one or more tabs extending away from a surface of the panel, and a hinge assembly for mounting the panel to the base assembly. The hinge assembly may create an attachment between the display panel and the base assembly such that the display assembly can be rotated about a vertical axis with respect to the base assembly. The hinge assembly may further include one or more side hinges that are adapted to receive the one or more tabs.

In a third exemplary embodiment, a device is provided. The device may include a center hinge removably anchored to a base assembly, a panel connected to the center hinge. The panel may be adapted to rotate and pivot about the center hinge and have a tab protruding from the panel in a lateral direction. The device may further include a side hinge attached to the base assembly adapted to accept the tab as the panel is rotated in a clockwise or counterclockwise direction with respect to the base assembly.

### BRIEF DESCRIPTION OF THE DRAWINGS

Advantages of the exemplary embodiments will be apparent to those of ordinary skill in the art from the following detailed description and the accompanying drawings, in which like reference numerals are used to indicate like elements.

FIG. 1 is a perspective view of an open device, according to one embodiment of the invention.

FIG. 2 is a perspective view of a closed device, according to one embodiment of the invention.

FIG. 3 is a perspective view of an open device, according to one embodiment of the invention.

FIG. 4 is a perspective view of an open device, according to one embodiment of the invention.

FIG. 5 is a perspective view of an open device being rotated, according to one embodiment of the invention.

FIG. 6 is a portion of a perspective view of an open device, according to one embodiment of the invention.

FIG. 7 is a cross-sectional view of a portion of an open device, according to one embodiment of the invention.

FIG. 8 is a cross-sectional view of a portion of an open device, according to one embodiment of the invention.

FIG. 9 is a cross-sectional view of a portion of a closed device, according to one embodiment of the invention.

FIG. 10 is a cross-sectional view of a portion of a closed device, according to one embodiment of the invention.

FIG. 11 is a perspective view of a side hinge for a device, according to one embodiment of the invention.

FIG. 12 is a perspective view of a panel for a device, according to one embodiment of the invention.

FIG. 13 is a portion of a perspective view of a panel for a device, according to one embodiment of the invention.

FIG. 14 is a perspective view of a side hinge for a device, according to one embodiment of the invention.

### DESCRIPTION

The following description conveys an understanding of embodiments that relate to devices and, more particularly, to a laptop having features that allow its display to rotate 180° or more. Many exemplary embodiments of devices having features that allow the display to rotate 180° or more are described below. Although the exemplary embodiments generally depict a laptop, the features that allow the display to rotate may be used in devices, structures, machines, or apparatuses other than laptops, such as DVD players, GPS systems, and cell phones. The exemplary embodiments may even be used in non-electronic devices, structures, machines, or apparatuses that may utilize a hinge mechanism for rotating a display, cover, storage compartment, antenna(s) . . . . The exemplary embodiments described below may be dimensioned differently and may have additional components not described, or components removed. One of ordinary skill in the art will appreciate alternative purposes, uses, and benefits for the exemplary embodiments depending on specific design needs and other considerations.

The terms used in describing exemplary embodiments are not intended to limit the scope of any particular exemplary embodiment. As used throughout this disclosure, the singular forms “a,” “an,” and “the” include the plural, unless the context clearly dictates otherwise, and vice versa.

The accompanying figures and following description depict and describe exemplary embodiments of a laptop with a self-engaging hinge mechanism. As used throughout this description, the term “laptop” or other like terms is meant to encompass any laptop—mini, lightweight, widescreen, and so on. The term “laptop” is also meant to encompass any type of laptop regardless of performance capabilities. But, the exemplary embodiments may also be used in any devices, machines, or apparatuses with a rotatable component.

With regard to the exemplary embodiments described below, any part that fastens, mounts, attaches, or connects any component to or from the laptop or hinge is not limited to any particular type and is instead intended to encompass all known and conventional fasteners, like screws, nut and bolt connectors, threaded connectors, snap rings, detent arrangements, claims, rivets, toggles, and so on. Any combination of these fitments can be used.

With regard to electronic parts of the exemplary embodiments, any known or conventional, or commercially available electronic components, connectors, or devices may be used. This includes wiring, connectors, printed circuit boards, microchips, lights, LEDs, and so on. Unless otherwise specifically disclosed, materials for making components of the exemplary embodiments may be selected from appropriate materials, such as metal, metal alloys, natural or manmade fibers, plastics, silicone, rubber, and so on. Any and all appropriate manufacturing or production methods, such as casting, pressing, extruding, molding, machining, may be used to construct the exemplary embodiments or their components.

When describing exemplary embodiments, any reference to front and back or rear, top and bottom, right and left, upper and lower, and so on, is intended to conveniently described those embodiments only. Spatial and positional references do not limit the exemplary embodiments or its components to any specific position or orientation.

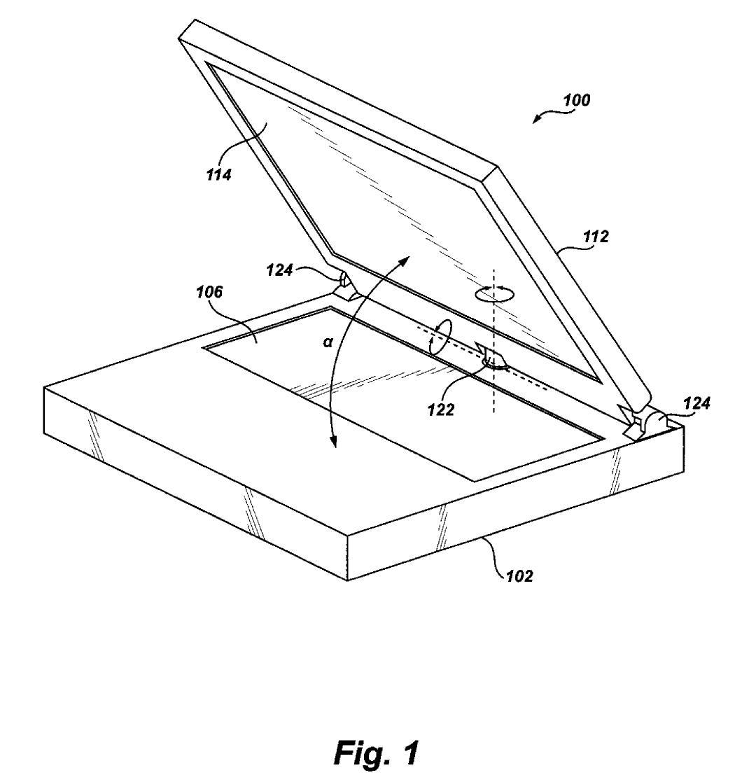

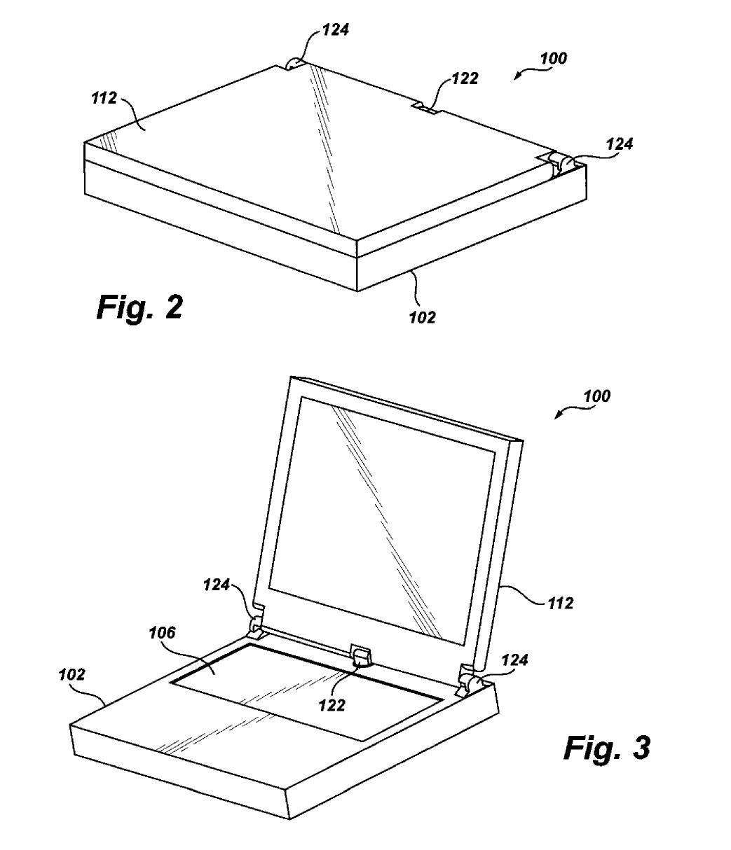

Exemplary embodiments will be described with reference to FIGS. 1 to 14. Referring to FIGS. 1 through 5, a laptop computer 100 is shown according to one exemplary embodiment. The laptop 100 comprises a base assembly 102 and a display panel 112. The base assembly 102 is a generally thin, rectangular base 104 that contains the well-known internal components of the laptop 100. On its upper surface, the base assembly 102 may have a keyboard 106, and other components, such as a touch pad. The display panel 112 may be removably or permanently connected to the base assembly 102. The display panel 112 may also be a generally thin, rectangular structure that comprises a screen 114. The screen 114 may comprise LCD, LED, OLED, or other display technologies. The screen 114 may further comprise touch panel capabilities, as are well known in the art. It is understood that the laptop 100, and its parts, may be any suitable dimension or shape and made of any suitable material, like metal, metal alloys, plastics, and so on.

The display panel 112 may be connected to the base assembly 102 via one or more hinges. In an exemplary embodiment, the laptop 100 may comprise three hinges, a base hinge 122, and two side hinges 124. Each hinge 122, 124 may be anchored to the base assembly 102 and extend upwardly for attachment to the display panel 112. Of course, each hinge 122, 124 may be anchored to the display panel 122 and extend downwardly for attachment to the base assembly 102. The one or more hinges 122, 124 may be designed and located such that they cooperatively work together to pivotally open and rotate the display panel 112 with respect to the base assembly 102, as will be further explained below.

In an exemplary embodiment, the hinge 122 may be a display hinge, centered in the back region of the base assembly 102 behind the keyboard 106. The two side hinges 124 may be located on opposite sides in the back region of the base assembly 102. In an exemplary embodiment, the two side hinges 124 may be collinear with the center hinge 122 and may be near the side of the base assembly 102. The side hinges 124 may be positioned at a predetermined distance from the center hinge 122 to improve the stability and robustness. The one or more hinges may be made of any suitable material, including but not limited to metal, metal alloys, natural or manmade fibers, plastics, or any combination thereof.

The hinge 122 may designed and configured to allow the display panel 112 to pivot from a closed position to an open one, and vice versa, as depicted in FIG. 1. The hinge 122 provides a pivotal relationship between the display panel 112 and the base assembly 102. The display panel 112 pivots about a horizontal axis of the hinge 122 so that a continuum of observation angles are provided to a user to view the display panel 112 during use. The range of pivotal angles for the display panel 112 may be set at any suitable range. Further, the hinge 122 may provide a rotational relationship between the display panel 112 and the base assembly 102. That is, the hinge 122 may allow the display panel 112 to rotate or swivel about a vertical axis of the hinge 122 so that a continuum of rotational angles are provided to a user to convert the laptop 100 from a notebook style laptop to a tablet style laptop and vice-versa. The range of rotational angles for the display panel 112 may be set to any suitable degree of rotation, including 360°.

The hinge 122 may comprise any number of components, including one or more shanks, spools, shafts, swivel shafts, washers, pins, brackets, plates, resilient or securing members, bosses, and so on. Any on of these hinges may be used with the exemplary embodiments described.

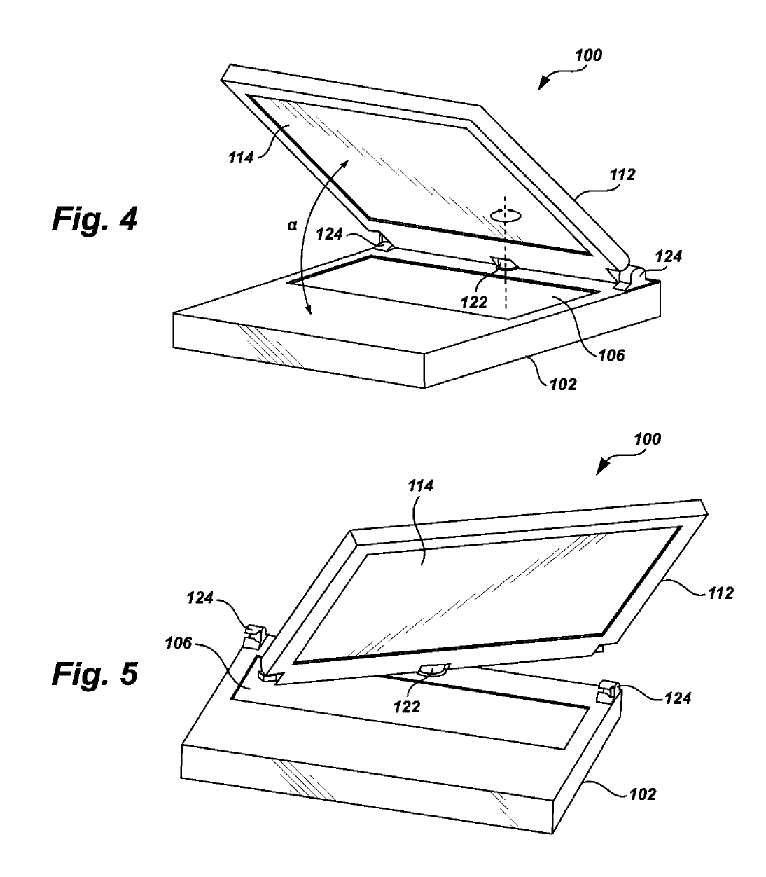

FIGS. 1-4 show the laptop 100 in a number of positions: a partially open, a closed position, and an open position. Referring to FIG. 4, the laptop 100 is in a partially open position, wherein the display panel 122 is likely not suitable for a user to easily and comfortably view the screen 114. This partially open position, however, may also be generally referred to as a hinge free angle α. A hinge free angle α is an angle between a closed and open position that allows for the display panel 112 to be rotated about a vertical axis of the hinge 122 and rotated with respect to the base assembly 102. A hinge free angle α may be set at a predetermined distance between the closed position and an open position. In use of an exemplary embodiment, a hinge free angle α may be halfway between the closed and open position. Referring to FIG. 5, the display panel 112 is shown as being disengaged from the hinges 122, 124 and rotated with respect to the base assembly 102. A hinge free angle α allows the display panel 112 to be rotated 180°, for example, thus allowing the laptop 100 to transform from a notebook style laptop to tablet style laptop, or vice versa.

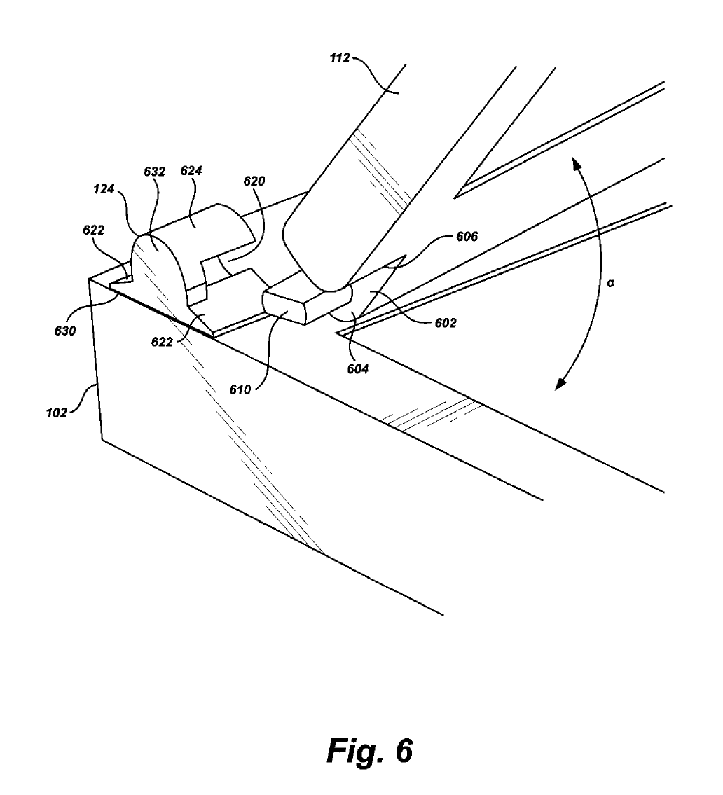

Referring now to FIG. 6, an exemplary embodiment of one of the side hinges 124 and a portion of the display panel 112 is shown magnified. In this exemplary embodiment, the display panel 112 may have a cutout 602. The cutout 602 may be located at the display panel's 112 lower, outside corner. The cutout 602 may be defined by an inside wall 604 and a top wall 606. A tab 610 may be attached to the cutout 602 and jut outwardly towards the hinge 124. The tab 610 may be attached to either the inside wall 604 or top wall 606 of the cutout 602. In an exemplary embodiment, the tab 610 may be formed as a double-D, flattened shaft. The double-D, flattened shaft may be configured with two diametrical side edges that have the same radius of curvature and two diametrical side edges that are straight. The tab 610 may be of any suitable thickness or length. The side hinge 124 may have a corresponding slot 620 adapted to receive the tab 610. The hinge 124 may comprises a base 630 that is attached to a top surface of the base assembly 102. The base 630 may further comprises one or more lead-ins 622, located on opposite sides of the hinge 124 that serve to guide the tab 610 into or out of the slot 620. In an exemplary embodiment, the hinge 124 may have a side wall 632 that is coplanar or nearly coplanar with the lateral edge of the base assembly 102.

When the display panel 112 is in a hinge free angle α, it may be rotated with respect to the base assembly 102 such that the tab 610 on the left side of the display panel engages the slot 620. The slot 620 is sized and shaped to receive the tab 610. The slot 620 extends through the side hinge 124 to allow the tab 610 on the right side of display panel 112 to engaged in the left side hinge once the display has been rotated 180° (tablet configuration) In an exemplary embodiment, the tab 610 does not snap into the side hinge 620 but is rather only received therein. The one or more side hinges 124 and tab 610 allow for the display panel 112 to be rotated secured in different positions without the need for a locking mechanism. As stated above, the one or more side hinges 124 will have a slot on the back of the hinge 124 to allow the display panel 112 to be rotated 180° with respect to the base assembly 102 so that the display panels right tab (610) is now engaged in the left hinge and vice-versa. Moreover, the one or more hinges 124 may have a top face 624 to prevent the tab 610 from being dislodged in the vertical direction. In an exemplary embodiment, the laptop 100 may provide a detent on the one or more tabs 610 to correspond with a hinge free angle α, thus creating a mechanism to allow a user to identify when the display panel 112 has been pivoted into a hinge free angle α and ready for rotation.

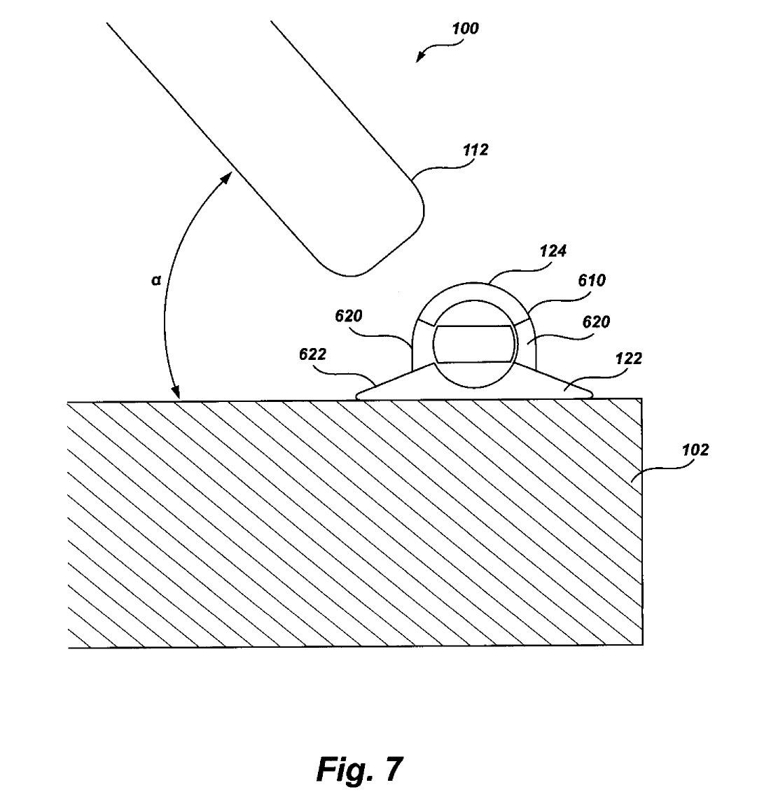

Referring now to FIG. 7, a cross-section of a portion of the laptop 100 is shown. In this exemplary embodiment, the display panel 112 is connected at all points with the base assembly 102. Specifically, the tab 610 has been engaged with the one or more side hinges 124 after the display panel 112 has been rotated. The exemplary embodiment further shows the display panel 112 in a hinge-free angle α. When in the display panel 112 is in a hinge free angle α, the tab 610 is rotationally aligned with the 620. This rotational alignment allows for the tab 610 to easily engage the side hinge 124, using the one or more lead-ins 622 if needed. This rotational alignment also allows for the display panel 112 to be disengaged from the side hinge 124 in either the forward or backward direction through the slot 620.

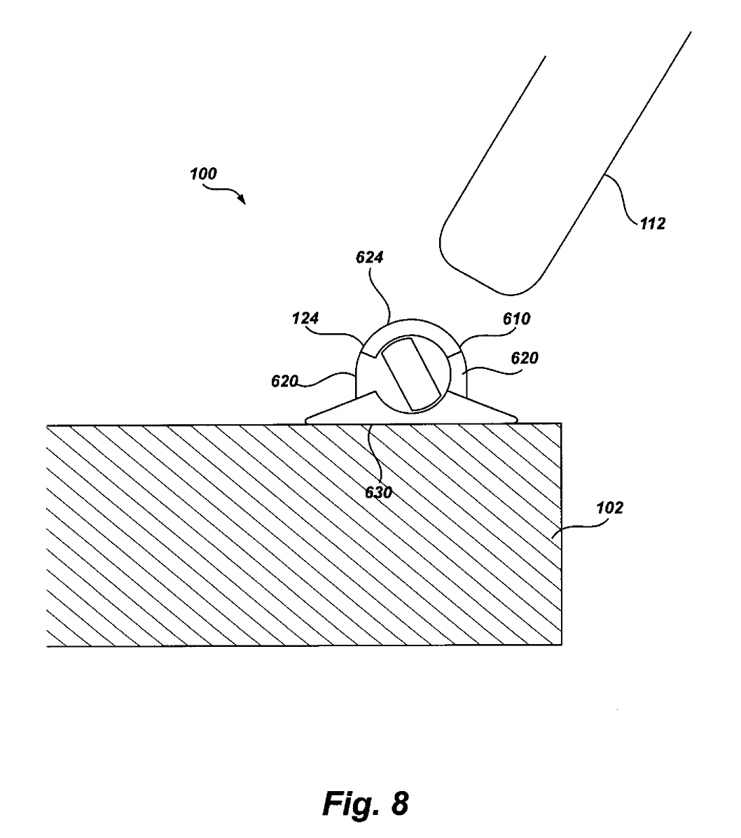

Referring to FIG. 8, a cross-section of a portion of the laptop 100 is shown. In this exemplary embodiment, the display panel 112 is connected at all points with the base assembly 102. Specifically, the tab 610 has been engaged with the one or more side hinges 124. The exemplary embodiment further shows the display panel 112 in the open position. When the display panel 112 is in the open position, the tab 610 is rotationally misaligned with the slot 620. This ensures that the display panel 112 will not become disengaged from the hinges 124. When misaligned, the ends of the tab 610 face the top face 624 and the base 630 of the side hinge 124. A user cannot rotate the display panel 112 with respect to the base 102 in either direction when the laptop 100 is in any position other than a hinge free angle α position.

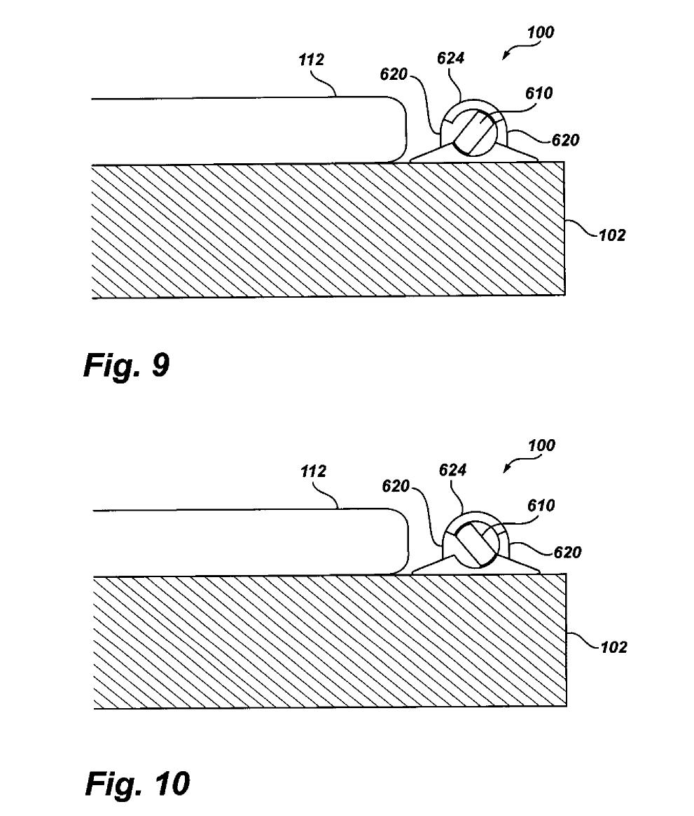

FIGS. 9 and 10 provide other embodiments of a cross-section of a portion of the laptop 100 that show the display panel 112 connected at all points with the base assembly 102 in a normal closed position or a tablet position. In these embodiments, the display panel 112 cannot rotate in any direction with respect to the base assembly 102. In these embodiments, the tab 610 is engaged with the side hinge 124 in that the tab 610 is fitted into the side hinge 124. The tab 610 is further rotationally misaligned within the side hinge 124 such that the display panel is securely held in place. That is, the parts are arranged and dimensioned such that the tab 610 cannot be disengaged without pivoting the display panel 122 into a hinge free angle α. Specifically referring to FIG. 10, this exemplary embodiment shows the display panel 112 in the tablet position—the position where the display panel 112 folds down on top of the base assembly 102 such that the screen faces upward.

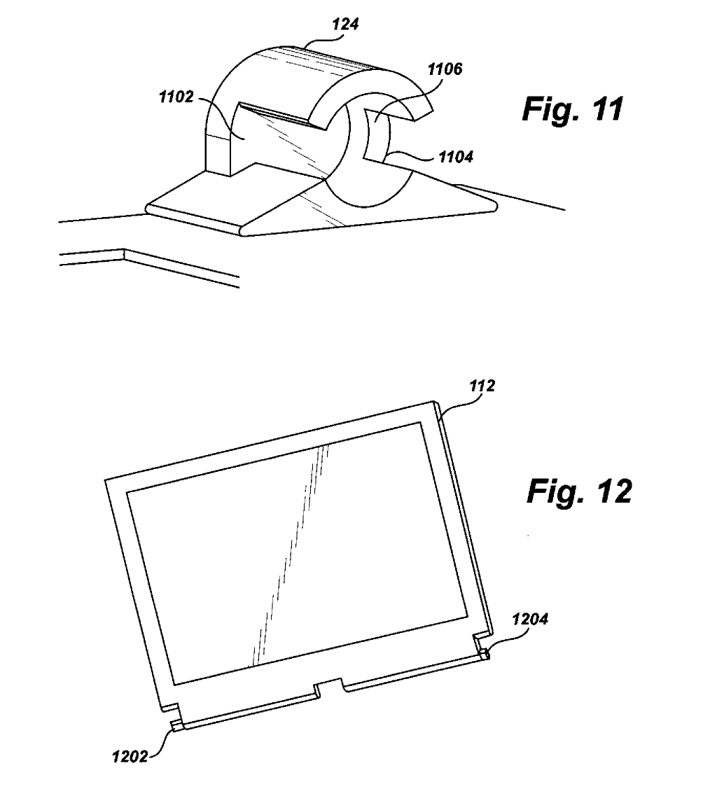

FIGS. 11 and 12 illustrate an alternative embodiment in which the side hinge 124 comprises a hard stop 1106 so that user can rotate the display panel quickly into the new orientation and then tilt the display panel so that the change hinge free angle α engages the side hinges. It also protects against potentially damaging the center hinge 122. In this embodiment, the side hinge 124 comprises an entrance slot 1102 and an exit slot 1104. The entrance slot 1102 has an opening that is deeper than that of the exit slot 1104. The exit slot 1104 comprises a hard stop 1106 at its end to prevent over rotation. The entrance and exit slots 1104 are still sized and shaped to engage and disengage the one or more tabs 610 of the display panel 112, as shown in FIG. 12. In this embodiment, the display panel 112 has a first tab 1202 and a second tab 1204. The first tab 1202 is longer than the second tab 1204. This design allows for the hard stop 1106 of the exit slot 1104 to contact the first tab after an initial 180° rotation to prevent the display panel from rotating in the same direction a full 360°. Furthermore, the hard stop 1106 of the one or more side hinges 124 only allows for the display panel 112 to be rotated in one direction. The entrance slot 1102 of the side hinge 124 is deep enough for the first tab 1202 to self-engage the side hinge 124, but the exit slot 1104 of the side hinge is less deep than the entrance slot 1102 such that the first tab 1202 will contact the hard stop 1106. The second tab 1204, being shorter than the first tab 1202 can pass by the hard stop 1106 in the one or more side hinges 124.

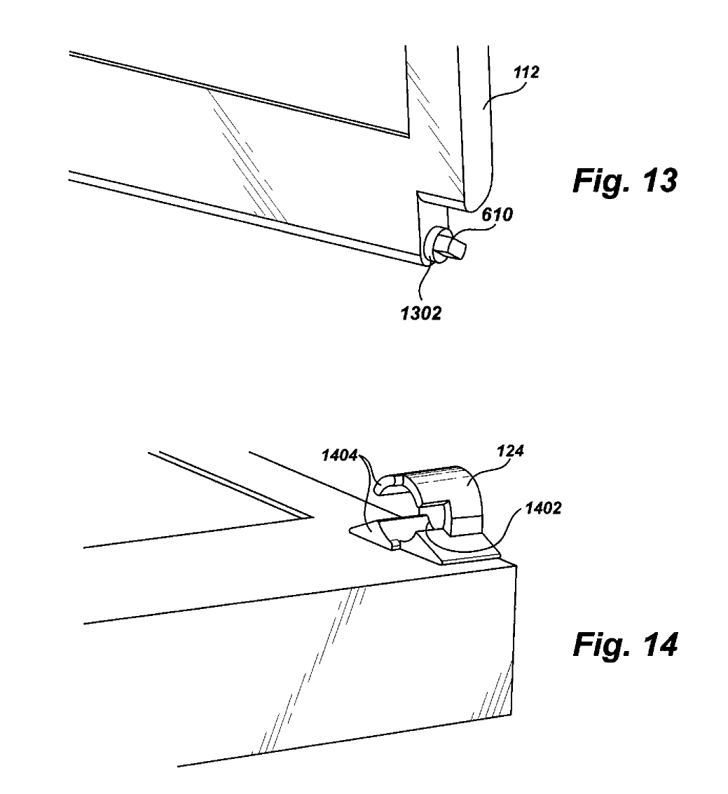

FIGS. 13 and 14 illustrate another alternative embodiment in which the side hinge 124 comprises a hard stop 1404 to prevent the display panel 112 from over rotating so that user can rotate the display panel quickly into the new orientation and then tilt the display panel so that the change hinge free angle α engages the side hinges. It also protects against potentially damaging the center hinge 122. In this embodiment, the tab 610 is modified to prevent the display panel 112 from over rotating as the tab has a round base 1302. Correspondingly, the side hinge 124, as shown in FIG. 14, comprises a slot 1402 adapted to receive the tab 610, including the round base 1302 of the tab 610. The side hinge further comprises a hard stop 1404 in the rear to prevent over rotation. Once the tab 610 and base are received into the one or more side hinges 124, the hard stop 1404 prevents the display panel 112 from being rotated in the same direction because it contacts the base 1302 of the tab 610. This design allows for the hard stop 1404 to contact the round base 1302 of the tab after an initial 180° rotation and prevent the display panel from rotating in the same direction a full 360°. Furthermore, the hard stop 1404 of the one or more side hinges 124 only allows for the display panel 112 to be rotated in one direction.

In another embodiment, the display panel 112 may have a slotted receiver formed therein that corresponds to one or more tabs 610 form integrally with the one or more side hinges 124. In this embodiment, the one or more tabs 610 would be attached to the base assembly 102 as opposed to the display panel 112.

This disclosure describes exemplary embodiments of laptops, including convertible laptops, that have features to allow a laptop to operate in a notebook and/or tablet style. Those embodiments may be used in any type of laptop. However, it will be understood that the foregoing embodiments may be used in any type device, structure, machine, or apparatus such as DVD players, GPS systems, and cell phones, or even non-electronic devices, structures, storage systems, machines, or apparatuses. Additionally, it will be understood that these and other embodiments are capable of use in various other combinations and environments and can be changed or modified without departing from the scope of the appended claims.

What is claimed is:

1. A hinge assembly for use with a laptop computer, the hinge assembly comprising:
a swivel hinge attached to a base assembly and to a display panel, the swivel hinge adapted to allow the display panel to pivotally and rotationally move with respect to the base assembly;
one or more side hinges attached to the base assembly, the one or more side hinges being generally collinear with the swivel hinge and having a slot formed therethrough;
wherein the one or more tabs are adapted to engage and release the display panel when the display panel is in a hinge free angle.

2. The hinge assembly of claim 1, wherein the display panel comprises a cutout located at the lower, outside corner of the display panel.

3. The hinge assembly of claim 1, wherein the display panel comprises one or more tabs.

4. The hinge assembly of claim 3, wherein the one or more tabs are configured and dimensioned to engage and release from the slot.

5. The hinge assembly of claim 3, wherein the one or more tabs of the display assembly are aligned with the slot of the one or more side hinges when the display panel is in a hinge free angle.

6. The hinge assembly of claim 3, wherein the one or more tabs of the display assembly are misaligned with the slot of the one or more side hinges when the display panel is not in a hinge free angle.

7. The hinge assembly of claim 1, wherein the one or more side hinges comprises a hard stop to prevent the display panel from over rotating when the display panel is in a hinge free angle.

8. The hinge assembly of claim 1, wherein the one or more side hinges are self-engaging and self-releasing.

9. A device, comprising:
a base assembly;
a panel pivotally attached to the base assembly and having one or more tabs extending away from a surface of the panel; and
a hinge assembly for mounting the panel to the base assembly, the hinge assembly creating an attachment between the display panel and the base assembly such that the display assembly can be rotated about a vertical axis with respect to the base assembly;
wherein the hinge assembly comprises one or more side hinges that are adapted to receive the one or more tabs.

10. The device of claim 9, wherein the one or more side hinges comprises a slot formed therethrough.

11. The device of claim 10, wherein the slot is shaped and dimensioned to receive the one or more tabs when the panel is pivoted to a predetermined open angle with respect to the base assembly.

12. The device of claim 10, wherein the one or more tabs are misaligned with the slot when the display panel is in the open and closed position.

13. The device of claim 10, wherein the one or more side hinges comprise a lead-in adapted to guide the one or more tabs into the slot when the panel is rotated.

14. The device of claim 9, wherein the one or more side hinges comprises a top face to prevent the one or more tabs from being dislodged in the vertical direction.

15. A device, comprising:
a center hinge removably anchored to a base assembly;
a panel connected to the center hinge, the panel adapted to rotate and pivot about the center hinge and having a tab protruding from the panel in a lateral direction; and
a side hinge attached to the base assembly adapted to accept the tab as the panel is rotated in a clockwise or counterclockwise direction with respect to the base assembly.

16. The device of claim 15, wherein the center hinge is adapted to allow the panel to rotate about a vertical axis.

17. The device of claim 15, wherein the side hinge comprises one or more slots into which the tab may extend when the panel is at a predetermined angle with respect to the base assembly.

18. The device of claim 15, wherein the side hinge comprises one or more slots into which the tab may extend that prevents the tab from moving in a vertical direction.

19. The device of claim 15, wherein the side hinge is configured and dimension to allow the tab to rotate therein to prevent the panel form disengaging from the side hinge.
